(19) United States
(12) Patent Application Publication
(10) Pub. No.: US 2026/0120976 A1
(43) Pub. Date: Apr. 30, 2026

(54) SURFACE-MOUNTED BACKLIT SWITCH

(71) Applicant: C&K COMPONENTS S.A.S., Dole (FR)

(72) Inventors: Laurent Bouvier, MONNIERES (FR); Fabrice Valcher, DOLE (FR)

(73) Assignee: C&K COMPONENTS S.A.S., Dole (FR)

(21) Appl. No.: 18/928,367

(22) Filed: Oct. 28, 2024

(51) Int. Cl. H01H 13/14; H01H 13/02; H01H 13/20

(52) U.S. Cl. CPC H01H 13/14; H01H 13/023; H01H 13/20

(57) ABSTRACT

Disclosed herein is a novel backlit surface mounted switch for an illuminated application. The backlit switch does not have an integrated LED or other type of light but is designed to be positioned over a light source mounted on or under a PCB, such that the light source shows through the actuator of the switch when illuminated.

### FIELD OF THE INVENTION

This application is related to the field of components for surface mounting on a printed circuit board (PCB), and, in particular, for surface-mounted switches and, more particularly, for illuminated surface-mounted switches.

### BACKGROUND

PCB-mounted light emitting diodes (LEDs) are compact light-emitting diodes designed specifically for direct attachment to a circuit board. They are small in size and configured for attachment a PCB either by solderable pads or as a surface mount component. PCB-mounted LEDs are often used as status or indicator lights or as backlighting for displays, keypads and control panels. They find use in automotive, consumer electronics and wearable technology applications, among others. They are capable of providing light in a variety of colors, including white. Form factors for PCB-mounted LEDs include surface-mounted diodes (SMD), chip-on board (COB) and duel, in-line package (DIP) devices.

Surface-mounted switches can be mounted directly on a PCB and are commonly used for momentary actions, such as turning on a device or providing a signal to a circuit to do perform a certain action, for example, as a reset button or to select a specific function or feature of the circuit. Surface-mounted switches find uses, for example, in consumer electronics, industrial equipment, automotive applications and medical devices.

Illuminated surface-mounted switches are known in the art. Such switches combine an integrated LED or other type of light (i.e., incandescent or neon) with a surface-mounted switch. Illuminated surface-mounted switches may exhibit independent illumination wherein the switch and light are independently electrically connected, or the switch and light may share an electrical connection. Typically, the status of the light is related to actuation of the switch. Several commercially-available examples of such switches are shown in FIG. 1. Illuminated surface mount switches may be covered by a user interface material showing the function of the switch, examples of which are shown in FIG. 2.

### SUMMARY

Disclosed herein is a novel backlit switch for an illuminated application. The backlit switch does not have an integrated LED or other type of light but is designed to be positioned over a light source, such that the light source shows through the actuator of the switch.

In various embodiments, the switch may be a surface-mount device designed to be mounted on the surface of a printed circuit board (PCB) covering the light source. The light source may be, for example, a surface mounted LED or the switch may cover an opening in the PCB through which light from another source is exposed.

Because the switch lacks an integrated light source, it can be manufactured at a lower cost than traditional illuminated switches. Additionally, the operation of the light source and the switch may be completely independent.

### BRIEF DESCRIPTION OF THE DRAWINGS

By way of example, a specific exemplary embodiment of the disclosed system and method will now be described, with reference to the accompanying drawings, in which:

FIG. 1 are illustrations of several commercially-available prior art illuminated surface mount switches.

FIG. 2 is an illustration of an exemplary application of illuminated switches.

FIG. 3 is an exploded view of one embodiment of the device.

FIG. 4 is a rotated perspective view of the main body of the device.

FIG. 5 is a rotated perspective view of the electrical contacts of the device.

FIG. 6 is a rotated perspective view of the electrical actuator of the device.

FIG. 7 is a rotated perspective view of the user actuator of the device.

FIG. 8 is a side cross-sectional view of the device.

FIGS. 9(A,B) show two additional embodiments of the device.

FIG. 10 is an electrical schematic of an exemplary embodiment of the device.

FIGS. 11(A-C) show the device in situ with various types of light sources.

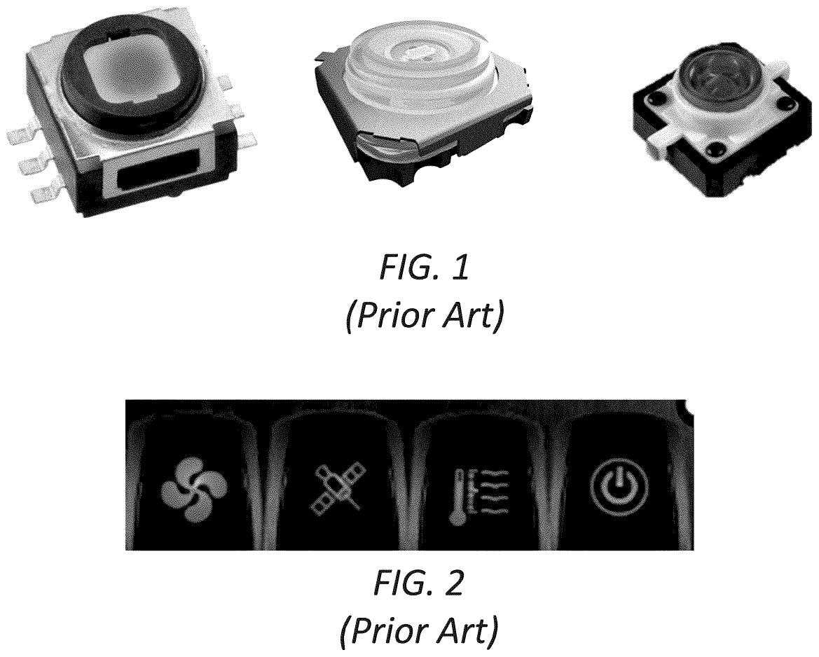

### DETAILED DESCRIPTION

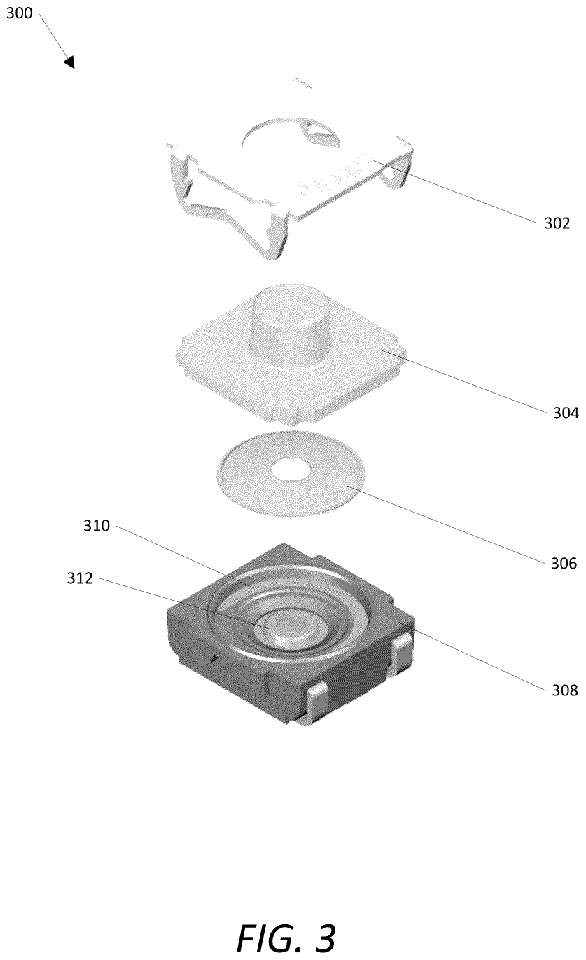

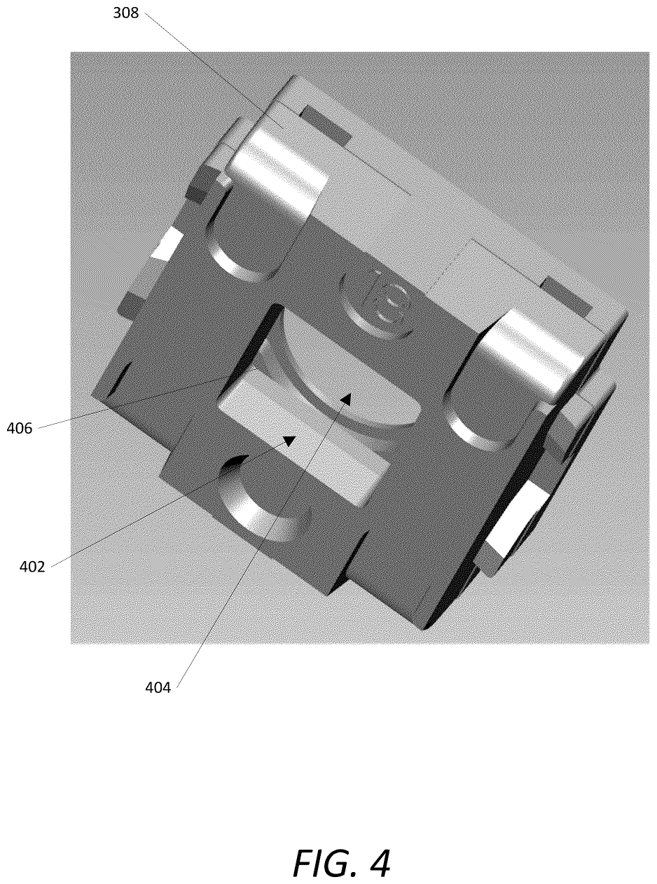

An exploded view of one embodiment of device 300 is shown in FIG. 3. The main body of device 300 comprises a molded body 308 which may be comprised of a plastic material, for example, polyamide, or any other non-electrically conductive, rigid material. A rotated perspective view of body 308 is shown in FIG. 4. Body 308 defines a recessed area 402 on the underside thereof having a through hole 404 defined therein that extends all of the way through body 308. Recessed area 402 is designed to accept a surface mounted light source when the switch is mounted over the light source on a PCB. Through hole 404 allows light from the light source to shine through body 308 of device 300.

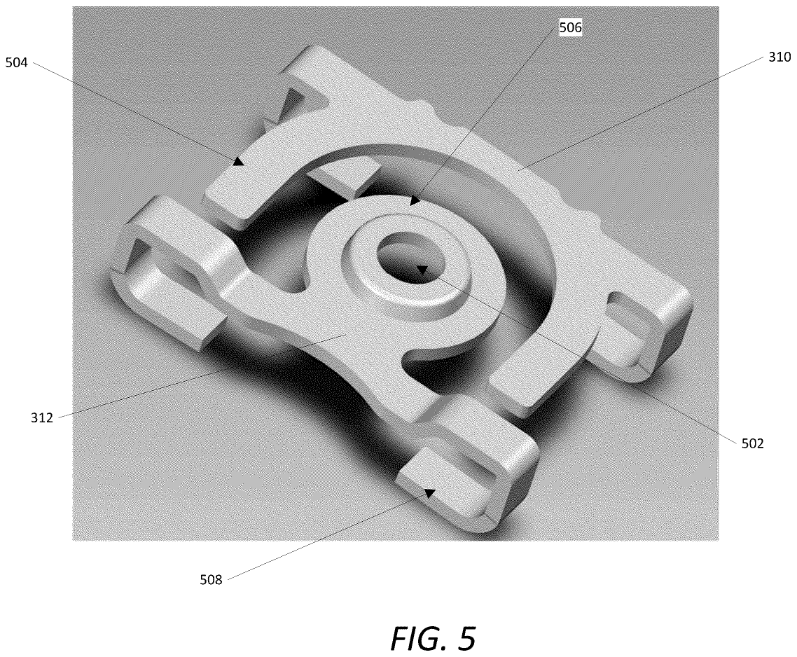

One exemplary embodiment of the electrical contacts of the switch is shown in rotated perspective view in FIG. 5. There are two electrical contacts 310, 312 which are disposed within body 308 and having legs 508 which extend to the exterior of body 308 to allow external connections. Contacts 310 and 312 are electrically connected when the switch is actuated. Electrical contact 312 defines a central ring portion 506 that covers hole 404 defined in body 308 of device 300. The ring portion 506 defines a hole 502 therein that is aligned with hole 404 in body 308 such as to allow light from the external light source to shine therethrough. Electrical contact 310 defines a substantially semicircular portion 504 disposed around ring portion 406 of contact 312 but not physically touching ring portion 506. Electrical contacts 310 and 312 define legs 508 that allow surface attachment of device 300 to a PCB via soldering to surface mount contact pads defined on the PCB. Electrical contacts 310, 312 may be composed of any conductive material, for example, copper, gold or silver plated copper or various alloys of conductive materials. As would be realized, the design of electrical contacts 310, 312 is not limited to the embodiment shown in FIG. 5, but may be of any configuration to allow electrical contact between any combination of the surface mount contact pads on the PCB, as long as the central portion of device 300, aligned with hole 404 in body 308, is kept free of obstructions such as not to block light from the external light source.

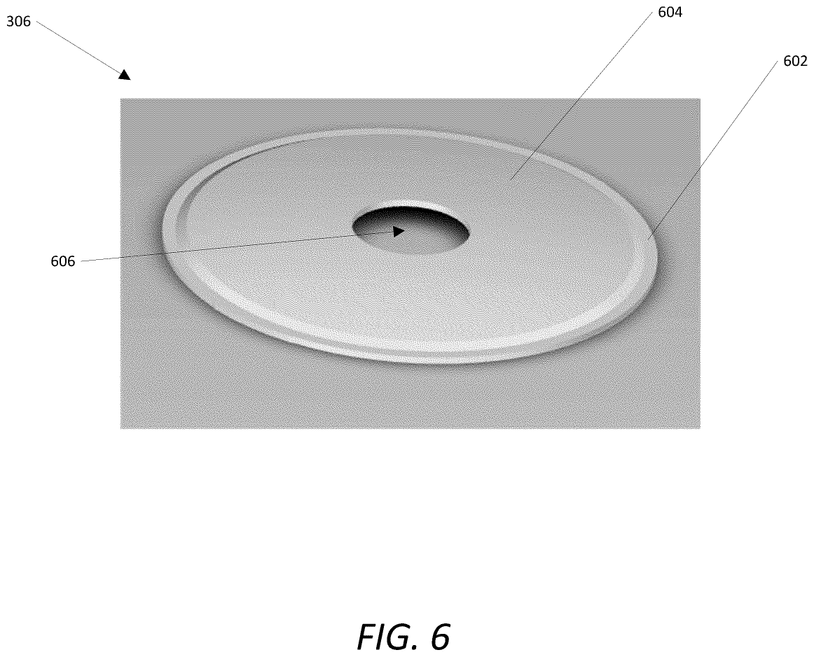

FIG. 6 shows the electrical actuator 306 that makes contact between electrical contacts 310 and 312. Electrical actuator 306 defines two portions, a rim 602 which sits on the semicircular portion 504 of contact 310 and a flexible domed portion 604 that, when pressed from above, flexes to contact ring portion 506 of contact 312, thereby electrically connecting contacts 310 and 312. When pressure on electrical actuator 306 is released, domed portion 604 returns to its unflexed position and breaks contact between contacts 310 and 312. Actuator 306 defines a hole 606 in the center thereof that allows light from the light source to shine therethrough. Electrical actuator 306 may be composed of any conductive material, for example, copper, gold or silver-plated stainless steel or various alloys of conductive materials.

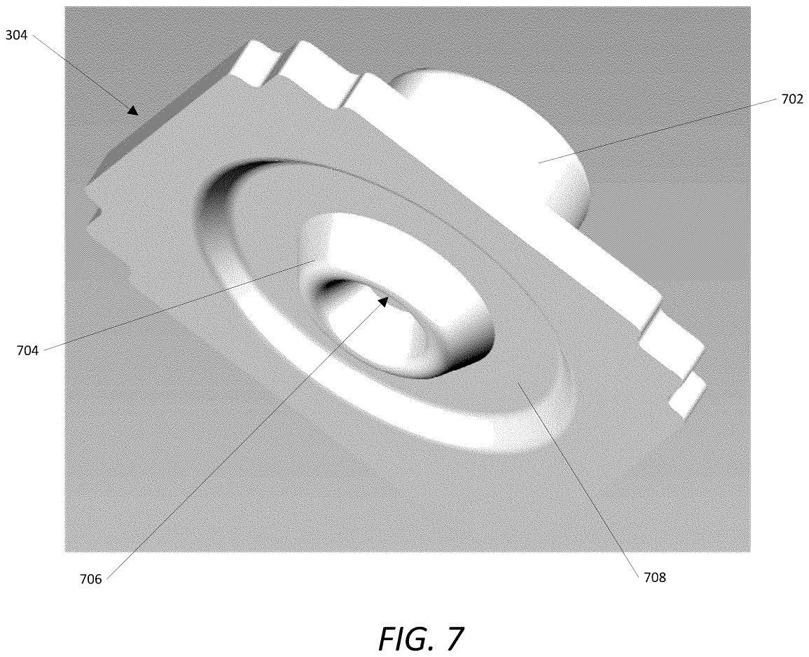

FIG. 7 shows user actuator 304, which is the portion of device 300 pressed by a user to actuate the switch. When a user presses on top portion 702 of user actuator 304, portion 704 applies pressure to electrical actuator 306 and forces the flexing of electrical actuator 306 that causes contact with ring portion 506 of contact 312, thereby establishing electrical contact between contacts 310 and 312. When pressure is released from top portion 702, electrical actuator 306 is allowed to unflex and push upwardly on portion 704, thereby breaking the electrical connection between contacts 310 and 312. User actuator 304 defines a hole 706 therein aligned with hole 502 in ring portion 506 and hole 404 in body 308, to allow light from the external light source to shine therethrough. Preferably, user actuator 304 is semi-rigid and composed of silicon or other semi-rigid materials such that area 708 is able to flex downwardly when pressure is applied to top portion 702. Preferably, user actuator 304 is transparent to allow the true color of the external light source to be visible to a user of device 300. Alternatively, actuator 304 may be colored to provide color to a white light source.

Device 300 is held together by a clip 302 having portions that engage complimentary portions on body 308. Preferably, clip 302 snap-fits into place and may be composed of a rigid material, for example, stainless steel. Clip 302 may be of any design and is not meant to be limited to the design shown in FIG. 3. Clip 302 defines a hole in the center thereof to allow top portion 702 of user actuator 304 to protrude therethrough.

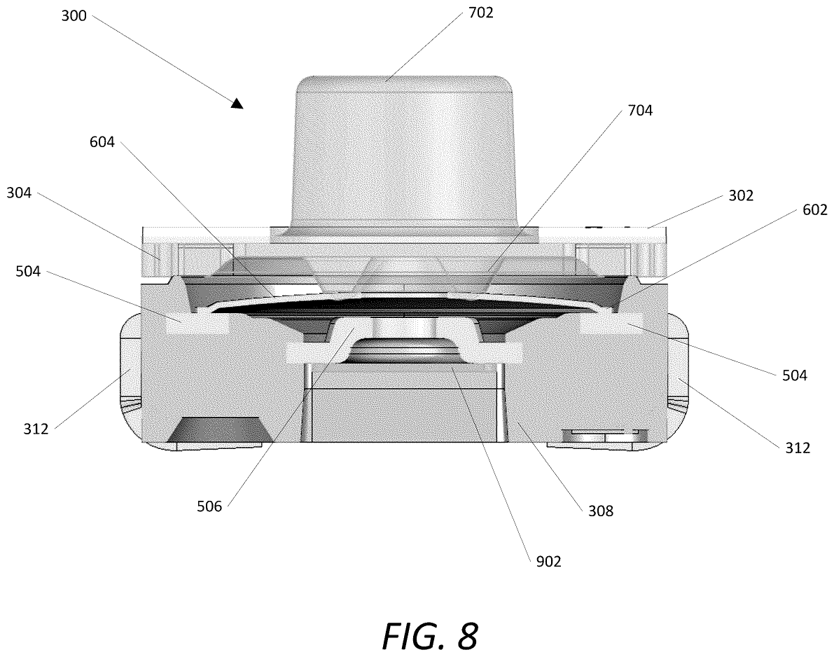

FIG. 8 is a side cross sectional view of device 300, showing how the previously described components interact with each other. The rimmed portion 602 of electrical actuator 306 sits on the semicircular portion 504 of electrical contact 310. When pressure is applied to top portion 702 of user actuator 304, portion 704 applies pressure to the domed portion 604 of electrical actuator 306, causing domed portion 604 to flex and contact ring portion 506 of electrical contact 312 thus electrically connecting contacts 310 and 312. When pressure is released from top portion 702 of user actuator 304, domed portion 604 of electrical actuator 306 unflexes, causing domed portion 604 to lose contact with ring portion 506 of electrical contact 310, thus breaking the electrical connection between electrical contacts 310 and 312. The contact between domed portion 604 of electrical actuator 306 and portion 704 of user actuator 302 keeps top portion 702 of user actuator 304 extended and in a position to be pushed.

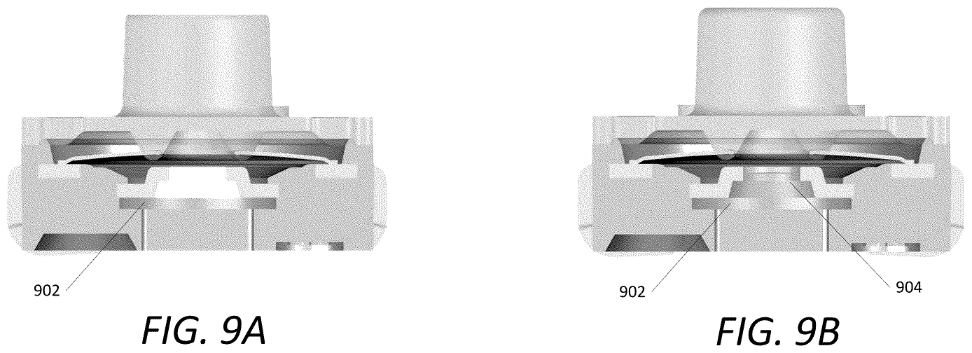

FIG. 9A shows an additional embodiment in which a transparent adhesive film or resin 902 seals the interior of device 300. The function of film 902 is to ensure the relative sealing of the switch against water and dust. Film 902 may rest on ledge 406 defined in recess 402 of body 308. FIG. 9B shows yet another embodiment in which a lens 904 is positioned in hole 404 defined in body 308 and may extend through hole 502 defined in ring portion 506 of electrical contact 312. Lens 904 may be shaped to match the shape of ring portion 506 of electrical contact 312. The purpose of lens 904 is to focus light from the external light source onto the interior of user actuator 304, such as to be visible to a user from top portion 702. Lens 904 may also be used without film 902. In various embodiments, lens 904 may be composed of an optical resin or optical glass.

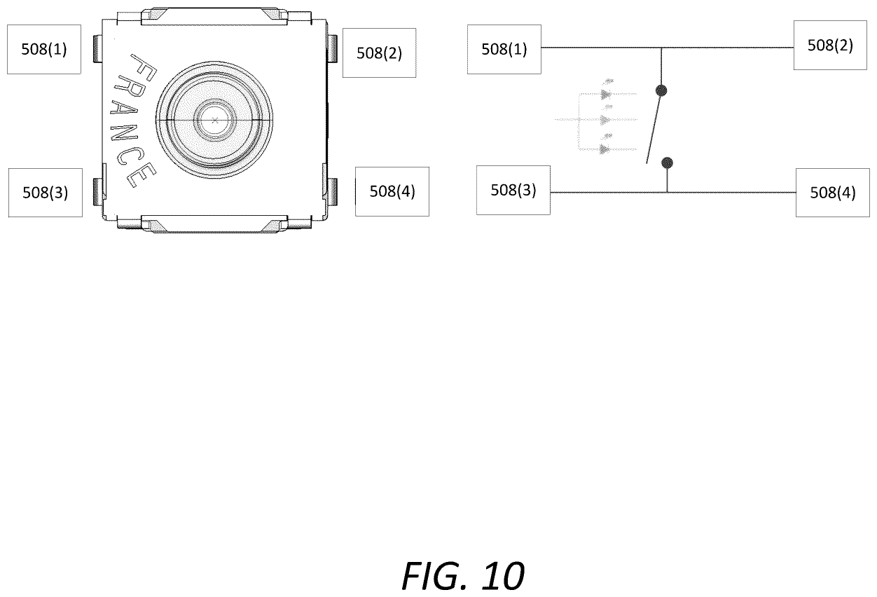

FIG. 10 is a schematic of the circuit in device 300. In the exemplary embodiment described herein, when the switch is actuated, legs 508(1) and 508(2) defined on electrical contact 310 are electrically connected to legs 508(3) and 508(4) defined on electrical contact 312. Other embodiments are possible in which activating device 300 electrically connects other combinations of legs 508(1-4).

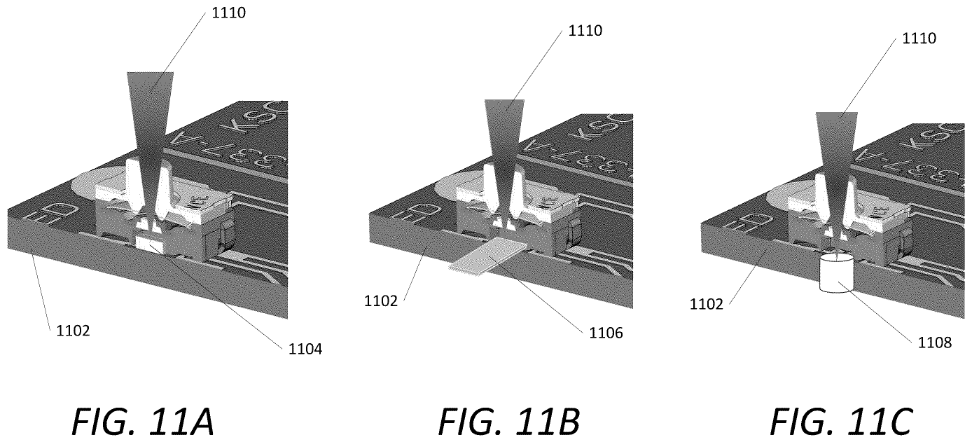

FIGS. 11(A-C) show cross sectional views of device 300 and PCB 1102, showing device 300 in situ mounted on the PCB with various types of light sources. FIG. 11A shows a surface mount LED 1104, wherein LED 1104 is received in recess 402 of body 308. The illustration shows the light 1110 shining up through the top portion 702 of user actuator 302. FIG. 11B shows a configuration similar to that of FIG. 11A, in which the light source is a LED film 1106. FIG. 11C shows use of device 300 wherein the light source is situated under the PCB board and wherein the light is transmitted through a hole in the PCB or via a light pipe 1108 extending through PCB 1102 and possibly into recess 402 of body 308.

In various embodiments, the size of device 300 and its components may vary, and the materials of which the components are constructed may also vary. In one embodiment, device 300 measures 6.2 mm×6.2 mm×3.5 mm. The total travel of the user actuator 302 is approximately ±3.5 mm, requiring an activation force of ±1N-4N. The electrical actuator 306 is ±5 mm in diameter. Body 308 and lens 904 may be composed of the same or similar materials, for example, White Translucid. It is expected that device 300 would have a lifetime of approximately 500,000 cycles.

1. A device comprising:
a body defining a recessed area and a through hole in communication with the recessed area and extending through the body;
a first and second electrical contacts disposed within the body;
an electrical actuator having a generally domed shape and defining a hole in a center thereof aligned with the through hole defined in the body, the electrical actuator contacting one of the first or second electrical contacts; and
a user actuator disposed over the electrical actuator;
wherein pressure applied to the user actuator causes the electrical actuator to flex and contact the other of the first or second electrical contacts, thereby establishing electrical contact between the first and second electrical contacts.

2. The device of claim 1 further comprising:
a clip having a hole defined in the center thereof through which a top portion of the user actuator extends;
wherein the clip is composed of a rigid material and defines one or more portions that engage complimentary portions defined on the body.

3. The device of claim 1 wherein the device is a surface mounted switch and further wherein the recessed area defined in the body covers a light source when the switch is mounted on a printed circuit board.

4. The device of claim 3 wherein the recessed area is sized and shaped to receive a surface mounted light source when the switch is mounted on the printed circuit board.

5. The device of claim 1 wherein the first electrical contact defines a substantially semicircular portion and further wherein the electrical actuator contacts the semicircular portion.

6. The device of claim 5 wherein the second electrical contact defines a ring portion disposed within but separated from the semicircular portion of the first electrical contact, the ring portion defining a hole in the center thereof aligned with the through hole defined in the body and the hole defined in the electrical actuator.

7. The device of claim 1 further comprising:
a transparent film or resin covering the through hole defined in the body.

8. The device of claim 6 further comprising:
a lens disposed between the body and the second electrical contact.

9. The device of claim 8 wherein the lens extends through the hole defined in the ring portion of the second electrical contact.

10. The device of claim 8 further compromising:
a transparent film or resin covering the through hole defined in the body.

11. The device of claim 1 wherein the user actuator is transparent and composed of a rigid material.

12. The device of claim 11 wherein the user actuator is composed of silicon.

13. The device of claim 1 wherein the electrical actuator and the first and second electrical contacts are composed of gold, copper or various alloys thereof.

14. The device of claim 1 wherein the first and second electrical contacts each define one or more leg portions extending through the body.

15. The device of claim 14 wherein the leg portions enable connection of the device to a printed circuit board via soldering.

16. The device of claim 1 wherein the body is composed of a rigid non-electrically conducting material.
